(19) United States
(12) Patent Application Publication
(10) Pub. No.: US 2025/0091565 A1
(43) Pub. Date: Mar. 20, 2025

(54) METHODS AND SYSTEMS FOR AUTOMATIC TESTING OF BRAKING FUNCTION FOR AUTONOMOUS OPERATION

(71) Applicant: CNH Industrial America LLC, New Holland, PA (US)

(72) Inventors: Mark D. Dilts, Mohnton, PA (US); Corrado Iotti, Ann Arbor, MI (US); Sudarshan Sirigere, Naperville, IL (US)

(21) Appl. No.: 18/469,842

(22) Filed: Sep. 19, 2023

(51) Int. Cl. B60T 17/22; B60K 35/00; B60T 1/00; B60T 7/12; B60T 8/92; B60T 13/22

(52) U.S. Cl. CPC B60T 17/22; B60K 35/00; B60T 1/005; B60T 7/12; B60T 8/92; B60K 35/10; B60K 35/22; B60K 35/28; B60K 2360/11; B60K 2360/161; B60T 13/22; B60T 2250/00; B60T 2250/04

(57) ABSTRACT

A method for automatically testing vehicle braking systems may include receiving, with a computing system, an input associated with performing an autonomous brake test of a vehicle braking system of a work vehicle and, in response to the input, autonomously releasing, with the computing system, a vehicle brake of the vehicle braking system. The method may further include autonomously engaging, with the computing system, a drive system of the work vehicle to initiate movement of the work vehicle and autonomously applying, with the computing system, the vehicle brake once the work vehicle has reached a predetermined speed or once the work vehicle has traveled a predetermined distance. Moreover, the method may include determining, with the computing system, whether the work vehicle has achieved a stopped condition upon application of the vehicle brake.

### FIELD OF THE INVENTION

The present subject matter relates generally to the testing of vehicle braking functions and, more particularly, to systems and methods of performing autonomous brake tests on vehicle braking systems.

### BACKGROUND OF THE INVENTION

Autonomous vehicles are capable of navigating and operating without operator input. These vehicles use a combination of advanced technologies, sensors, and software to make decisions, and control movements.

As autonomous vehicles develop, there are certain safety-critical items that are difficult to recover from in the case of a failure. For example, an operator can detect brakes becoming weak over time and request service, or the operator can take immediate action in case of a failure. This is much more difficult to do with an autonomous vehicle, thus prevention is key.

Accordingly, the testing of braking systems prior to autonomous operation of a vehicle is an important step for maintaining the safety of an operator and others within the surrounding area of the vehicle function to take over operation is critical. In this regard, improved methods and system for performing autonomous brake tests on vehicle braking systems would be welcomed in the technology.

### BRIEF DESCRIPTION OF THE INVENTION

Aspects and advantages of the invention will be set forth in part in the following description, or may be obvious from the description, or may be learned through practice of the invention.

In one example aspect, the present subject matter is directed to a method for automatically testing vehicle braking systems. The method may include receiving, with a computing system, an input associated with performing an autonomous brake test of a vehicle braking system of a work vehicle and, in response to the input, autonomously releasing, with the computing system, a vehicle brake of the vehicle braking system. The method may further include autonomously engaging, with the computing system, a drive system of the work vehicle to initiate movement of the work vehicle and autonomously applying, with the computing system, the vehicle brake once the work vehicle has reached a predetermined speed or once the work vehicle has traveled a predetermined distance. Moreover, the method may include determining, with the computing system, whether the work vehicle has achieved a stopped condition upon application of the vehicle brake.

In another example aspect, the present subject matter is directed to a method for automatically testing vehicle braking systems. The method may include performing, with a computing system, a first semi-automated brake test on a vehicle braking system of a work vehicle while the work vehicle is in a stopped condition. The first semi-automated brake test comprises prompting an operator to apply a vehicle brake of the vehicle braking system and autonomously engaging a drive system of the work vehicle while the operator maintains the vehicle brake applied. The method may also include determining, with the computing system, whether the work vehicle remains in the stopped condition during the performance of the first semi-automated brake test. The method may further include performing, with the computing system, a second autonomous brake test on the vehicle braking system. The second autonomous brake test comprises autonomously releasing the vehicle brake with the work vehicle in the stopped condition, autonomously engaging the drive system of the work vehicle to initiate movement of the work vehicle, and autonomously applying the vehicle brake once movement of the work vehicle has been initiated. In addition, the method may include determining, with the computing system, whether the work vehicle has been brought back into the stopped condition after the work vehicle has reached a predetermined speed or once the work vehicle has traveled a predetermined distance.

In yet another exemplary aspect, the above-described methods are embodied in the form of a computer-readable medium that stores processor-executable code for implementing the method.

In yet another exemplary embodiment, a device or system that is configured or operable to perform the above-described methods is disclosed. In one embodiment, the device or system comprises a processor configured to implement the method.

The above and other aspects and their implementations are described in greater detail in the drawings, the descriptions, and the claims.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 illustrates a illustrates a side view of one embodiment of a work vehicle in accordance with aspects of the present subject matter;

FIG. 2 illustrates a illustrates a block diagram of an example system that can be used to implement various components, systems, and methods in accordance with aspects of the present subject matter;

FIG. 3 illustrates a illustrates a flow diagram of one embodiment of a method for automatically testing vehicle braking systems of a work vehicle in accordance with aspects of the present subject matter;

FIG. 4 illustrates a illustrates a flow diagram of another embodiment of a method for automatically testing vehicle braking systems of a work vehicle in accordance with aspects of the present subject matter; and

FIG. 5 illustrates a illustrates a flow diagram of a further embodiment of a method for automatically testing vehicle braking systems of a work vehicle in accordance with aspects of the present subject matter.

### DETAILED DESCRIPTION OF THE INVENTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

In general, the present subject matter is directed to methods and related systems for automatically testing vehicle braking systems. Specifically, in several embodiments, the disclosed methods may be used to perform, by an operator and/or a computing system, various types of semi-automated and/or automated brake tests prior to allowing a work vehicle to operate autonomously. For example, as will be described below, an operator, in one embodiment, can be prompted to perform a semi-automated brake test in which the operator engages the vehicle's brakes while the autonomous system attempts to engage the drive system and move the vehicle. Additionally, or as an alternative thereto, the autonomous system, itself, may be configured to perform one or more autonomous brake tests, such as a stationary autonomous brake test and/or a dynamic autonomous brake test. As a result of passing the relevant brake test(s), the vehicle's braking system can be deemed safe for autonomous operation.

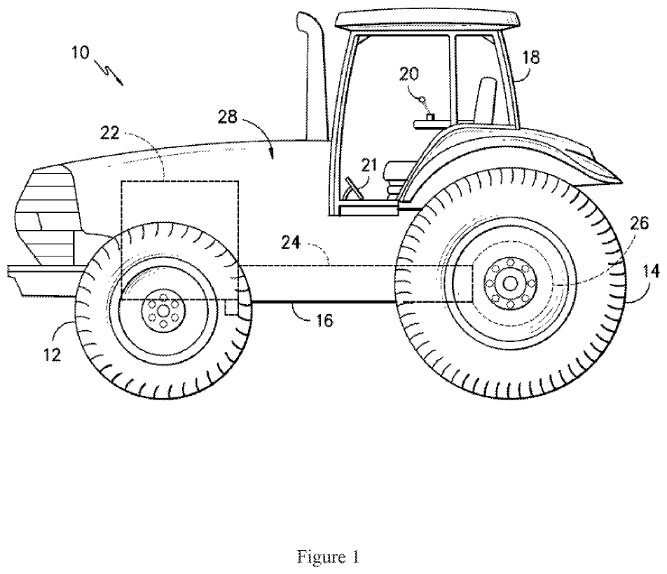

Referring now to the drawings, FIG. 1 illustrates a side view of one embodiment of a work vehicle 10. As shown, the work vehicle 10 is configured as an agricultural tractor. However, in other embodiments, the work vehicle 10 may be configured as any other suitable work vehicle known in the art, such as various other agricultural vehicles, earth-moving vehicles, loaders and/or various other off-road vehicles.

As shown in FIG. 1, the work vehicle 10 includes a pair of front wheels 12, a pair or rear wheels 14 and a chassis 16 coupled to and supported by the wheels 12, 14. An operator's cab 18 may be supported by a portion of the chassis 16 and may house various input devices, such as a control lever 20 and/or a brake pedal 21, for permitting an operator to control the operation of the work vehicle 10. For instance, the brake pedal 21 may be actuated to apply or engages the vehicle's brakes.

Additionally, the work vehicle 10 may include an engine 22 and a transmission 24 mounted on the chassis 16. The transmission 24 may be operably coupled to the engine 22 and may provide variably adjusted gear ratios for transferring engine power to the wheels 14 via a drive axle assembly 26. The engine 22, transmission 24, and drive axle assembly 26 may collectively define a drive system 28 of the work vehicle 10.

It should be appreciated that the configuration of the work vehicle 10 described above and shown in FIG. 1 is provided only to place the present subject matter in an exemplary field of use. Thus, it should be appreciated that the present subject matter may be readily adaptable to any manner of work vehicle configuration 10. For example, in an alternative embodiment, a separate frame or chassis may be provided to which the engine 22, transmission 24, and drive axle assembly 26 are coupled, a configuration common in smaller tractors. Still other configurations may use an articulated chassis to steer the work vehicle 10, or rely on tracks in lieu of the wheels 12, 14. Additionally, although not shown, the work vehicle 10 may also be configured to be operably coupled to any suitable type of work implement, such as a tillage implement, air seeder, planter, spray boom, and/or the like.

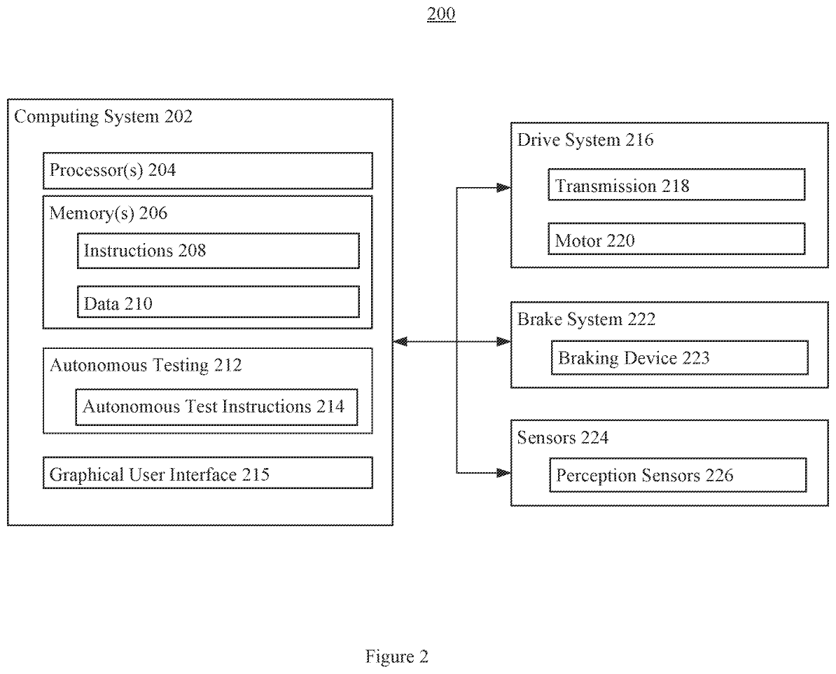

FIG. 2 depicts a block diagram of an example system 200 that can be used to implement various components, systems, and methods in accordance with aspects of the present subject matter. The system 200 may, in one embodiment, incorporate or be associated with one or more computing devices integrated into a work vehicle and/or one or more portable or remote computing devices, such as tablets or mobile devices, computer terminals, and/or other suitable devices. For purposes of discussion, the system 200 will generally be described herein with reference to the work vehicle 10 shown and described above with reference to FIG. 1. However, it should be appreciated that the system 200 may generally be utilized in association with work vehicles have any other suitable vehicle configuration.

In several embodiments, the system 200 can include a computing system 202. The computing system 202 may generally include one or more computing devices, including one or more computing devices integrated into or local to the work vehicle 10 and/or one or more computing devices remote to the work vehicle 10. In this regard, the computing system 202 can include one or more processor(s) 204 and one or more memory device(s) 206. The processor(s) 204 can include any suitable processing device, such as a microprocessor, microcontroller, integrated circuit, logic device, or other suitable processing device. The memory device(s) 206 can include one or more computer-readable media, including, but not limited to, non-transitory computer-readable media, RAM, ROM, hard drives, flash drives, or other memory devices.

The memory device(s) 206 can store information accessible by the processor(s) 204, including computer-readable instructions 208 that can be executed by the processor(s) 204. The instructions 208 can be any set of instructions that when executed by the processor(s) 204, cause the processor(s) 204 to perform operations. The instructions 208 can be software written in any suitable programming language or can be implemented in hardware. In some embodiments, the instructions 208 can be executed by the processor(s) 204 to cause the processor(s) 204 to perform operations, such as the operations for communication, data replication, and data sharing.

The computing system 202 can also include or be configured to execute an autonomous testing module 212 used to perform automated or semi-automated brake tests on a vehicle braking system, as will be described in several embodiments below. In one embodiment, in addition to executing or implementing one or more of the brake tests disclosed herein, the autonomous testing module 212 may also be configured to provide autonomous test instructions 214 to an operator regarding information, instructions, or the status of the executed brake tests. For example, the autonomous testing module 212 may be configured to provide operator prompts that instruct the operator to perform certain steps as part of the brake test being perform, such as when a semi-automated test is being performed or when the system has detected a failure of the autonomous system and the operator is required to intervene. Similarly, the autonomous testing module 212 may be able to provide a report or summary of each braking test performed, including whether the braking system passed the relevant test(s) and, thus, is suitable for use within autonomous operation. In one embodiment, the autonomous testing module 212 may be configured to provide such outputs to the operator via an associated graphical user interface 216 of the system 200.

In several embodiments, the graphical user interface 215 can form part of or be incorporated into the computing system 202 to allow outputs and other data generated or processed by the computing system 202 to be presented to the operator. Alternatively, the graphical user interface 215 can be completely separate from the computing system 202 and communicatively coupled thereto (e.g., via a wired or wireless connection) to allow data and other information to be exchanged between the computing system and the graphical user interface 215. As indicated above, the graphical user interface 215 can visualize or present brake test information to the operator and can provide interactive test information to the operator as well as receive operator inputs. Suitable test information may include, but is not limited to, autonomous test instructions, status, and/or results, and the work vehicle status.

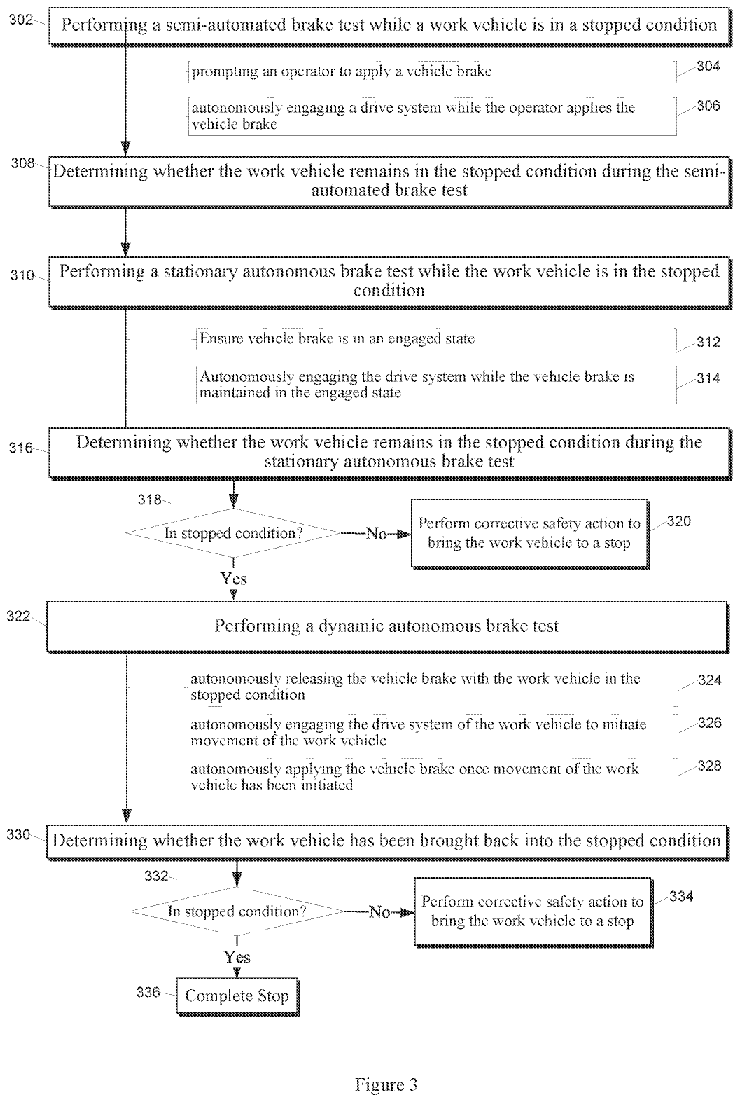

As shown in FIG. 3, the computing system 202 may also be configured to connect to and receive information from one or more systems, sub-systems, and/or components of the work vehicle 10 and/or other components of the system, such as a drive system 216 (e.g., drive system 28 of vehicle 10), a braking system 222, various sensors 224 (e.g., including perception sensors 226), and/or the like. As indicated above, the drive system may include various systems, sub-systems, and/or components for driving a work vehicle, such as a transmission 218 (e.g., transmission 24 of vehicle 10), a motor 220 (e.g., motor 22 of vehicle 10), and/or the like. Similarly, the braking system 222 may include various systems, sub-systems, and/or components for braking a work vehicle. For instance, the braking system 222 may include any suitable braking device(s) 223 for slowing movement of the work vehicle, such as a spring-applied, hydraulic release brake(s) or any other suitable braking device(s). As is generally understood, such braking device(s) 223 may be manually actuated or applied by the operator (e.g., via brake pedal 21 of vehicle 10). In addition to such manual activation, the braking device 223 may also be autonomously operated by the computing system 202 to allow the braking device 223 to be automatically engaged and disengaged during autonomous operation (and during performance of the brake tests described herein).

It should be appreciated that the sensors 224 may include any suitable sensors or sensing devices, including, but not limited to, pressure sensors, position sensors, motion sensors, cameras, LIDAR devices, speed sensors and/or the like. As indicated above, the sensors 224 may include various perception sensors 226 for accommodating autonomous operation of the work vehicle.

The technology discussed herein makes reference to computer-based systems and actions taken by and information sent to and from computer-based systems. One of ordinary skill in the art will recognize that the inherent flexibility of computer-based systems allows for a great variety of possible configurations, combinations, and divisions of tasks and functionality between and among components. For instance, processes discussed herein can be implemented using a single computing device or multiple computing devices working in combination. Databases, memory, instructions, and applications can be implemented on a single system or distributed across multiple systems. Distributed components can operate sequentially or in parallel.

Referring now to FIG. 3, a flow diagram of one embodiment of a method 300 for automatically testing braking systems of a work vehicle is illustrated in accordance with aspects of the present subject matter. Although FIG. 3 depicts steps performed in a particular order for purposes of illustration and discussion, the methods discussed herein are not limited to any particular arrangement. One skilled in the art, using the disclosures provided herein, will appreciate that various steps of the methods disclosed herein can be omitted, rearranged, combined, and/or adapted in various ways without deviating from the scope of the present disclosure. Additionally, for purposes of discussion, any computer-implemented steps of the disclosed method 300 will be generally described herein as being performed by the computing system 202 shown and described above with reference to FIG. 2. However, one of ordinary skill in the art will appreciate that the various computer-implemented steps can generally be executed by any suitable computing system having any suitable system configuration.

As shown in FIG. 3, at (302), the method 300 may include performing a semi-automated brake test in association with an operator while a work vehicle, such as an agricultural tractor or any other suitable work vehicle, is in a stopped condition (i.e., the vehicle is not moving). As shown in FIG. 3, to implement the semi-automated brake test, the computing system 202 may, at (304), be configured to prompt an operator (e.g., via the graphical user interface 215) to apply the vehicle's brakes (e.g., braking device 223 of braking system 222). For instance, the computing system 202 may provide interactive test instructions 214 prompting the operator to apply the brake pedal 21 or otherwise engage the braking device 223 of the work vehicle 10. Upon application of the brakes by the operator, the computing system 202 may, at (306), be configured to autonomously engage the vehicle's drive system (e.g., drive system 216) in an attempt to autonomously drive or move the vehicle while the operator maintains the brake in the applied state. For instance, the computing system 202 may engage the drive system in a predetermined gear selected for the brake test.

Next, at (308), the method 300 may include determining that the work vehicle remains in the stopped condition during the semi-automated brake test. Specifically, the computing system 202 may be configured to verify that the vehicle's brakes have maintained the work vehicle in the stopped condition despite attempting to drive the work vehicle via engagement of the drive system. In this regard, the computing system 202 may be configured to determine that the work vehicle has remained in the stopped condition in any suitable manner, such as by receiving feedback from any number of suitable sensors (e.g., sensors 224, including perception sensors 226). For instance, when the work vehicle is equipped with one or more speed sensors (e.g., wheel speed sensors, transmission input/output speed sensors, motor speed sensors, ground speed sensors such as GPS devices, and/or the like), the computing system 202 may verify that the work vehicle 10 has not moved based on feedback (or a lack thereof) form such sensors. Similarly, feedback from various types of perception sensors 226, such as cameras, LIDAR devices, and/or the like, may be analyzed to verify that the work vehicle has not moved during the brake test (and, thus, has remained in the “stopped condition”).

It should be appreciated that, in certain instances, the above-described “semi-automated” brake test may be skipped or removed from the overall brake testing procedure. For instance, if the computing system 202 determines that, with a given time period (e.g., within the last several hours), the operator has successfully applied the brakes (e.g., via manual activation) to stop the work vehicle (or to maintain the work vehicle in a stooped condition), the computing system 202 may identify that the “semi-automated” brake test is unnecessary or has otherwise been successfully completed due to such recent braking activities.

Referring still to FIG. 3, at (310), the method 300 may include performing a stationary autonomous brake test while the work vehicle is in the stopped condition. As shown in FIG. 3, to implement the stationary autonomous brake test, the computing system 202 may be configured at, (312), to verify that the vehicle's brake is in the engaged/applied state and, if not, autonomously engage the brake. For example, assuming the semi-automated brake test was performed immediately prior to stationary autonomous brake test, the computing system 202 may be configured to simply maintain the vehicle brake in the engaged state following release of the brake pedal 21 by the operator. With a spring-applied, hydraulic release brake, this may be achieved by simply maintaining the hydraulic braking cylinder in the activated or engaged state. Upon verifying that the brake engaged, the computing system may, at (314), be configured to autonomously engage the drive system while the vehicle brake is maintained in the engaged state. As indicated above, this may be achieved by the computing system 202 engaging the drive system in a predetermined gear selected for the brake test in an attempt to autonomously drive or move the vehicle while the brake is in the engaged state.

Further, at (316), the method 300 may include determining, that the work vehicle remains in the stopped condition during the stationary autonomous brake test. Specifically, similar to the semi-automated brake test described above, the computing system 202 may be configured to verify that the vehicle's brakes (now being autonomously applied) have maintained the work vehicle in the stopped condition despite attempting to drive the work vehicle via engagement of the drive system. As shown at (318), if the computing system 202 determines that the work vehicle has remained in the stopped condition, the stationary autonomous brake test may be considered to be successfully completed. However, if the work vehicle begins to move upon engagement of the vehicle drive system (and despite the brakes being applied), the computing system 202 may, at (320), be configured to perform a corrective safety action to bring the work vehicle to a stop. For instance, the computing system 202 may be configured to autonomously engage the drive system (e.g., by engaging the motor) in an attempt to utilize motor braking to stop the vehicle. In addition to such drive system engagement (or as an alternative thereto), the computing system may be configured to prompt the operator (e.g., via the graphical user interface 215) to manually apply the brakes to bring the vehicle to a stop. In such instances, the computing system 202 may identify that the brake test was unsuccessful and, thus, the work vehicle should not be operated in an autonomous mode due to issues with the braking system.

Referring still to FIG. 3, at (322), the method 300 may also include performing a dynamic autonomous brake test. Unlike the previously described brake test, the dynamic autonomous brake test is used to test the braking functionality of the work vehicle while the vehicle is in movement. As shown in FIG. 3, to implement the dynamic autonomous brake test, the computing system 202 may be configured, at (324), to autonomously release the vehicle brake while the work vehicle in the stopped condition. For instance, assuming the stationary autonomous brake test was performed immediately prior to dynamic autonomous brake test, the computing system 202 may be configured to automatically control the operation of the braking system to release the brakes. With a spring-applied, hydraulic release brake, this may be achieved by automatically controlling the hydraulic braking cylinder to disengage the brakes (e.g., by supplying pressurized fluid within the braking cylinder such that the cylinder disengages the brake against the bias of the spring-applied mechanism). Thereafter, with the brakes disengaged, the computing system 202 may, at 326, be configured to autonomously engage the vehicle's drive system to initiate movement of the work vehicle. For instance, the computing system 202 may be configured to engage the drive system in an attempt to move the vehicle forward at a predetermined speed or to a predetermined distance. Thereafter, at (328) following the initiation of movement of the work vehicle (e.g., upon the work vehicle achieving a desired speed or upon the vehicle traveling a desired distance), the computing system 202 may be configured to autonomously apply the vehicle brake in an attempt to bring the vehicle to a stop. For example, with a spring applied, hydraulic release brake, the computing system 202 may be configured to depressurize the braking cylinder to allow the spring-applied mechanism to activate or engage the brake.

Moreover, at (330), the method 300 may include determining whether the work vehicle has been brought back into the stopped condition upon re-engagement of the brakes. Specifically, the computing system 202 may be configured to verify that the vehicle's brakes have successfully slowed the work vehicle down to a stopped condition (e.g., via the use of speed sensors, perception sensors, and/or the like). As shown at (332), if the computing system 202 determines that the work vehicle is back in the stopped condition, the dynamic autonomous brake test may be considered to be successfully completed, in which case the brake test procedure can be considered complete (e.g., at 326). However, if the work vehicle is still moving despite the computing system attempting to apply the brakes to stop the vehicle, the computing system 202 may, at (334), be configured to perform a corrective safety action to bring the work vehicle to a stop. For instance, similar to the stationary autonomous brake test described above, the computing system 202 may be configured to autonomously engage the drive system (e.g., by engaging the motor) in an attempt to utilize motor braking to stop the vehicle and/or prompt the operator (e.g., via the graphical user interface 215) to manually apply the brakes to bring the vehicle to a stop. In such instances, the computing system 202 may identify that the brake test was unsuccessful and, thus, the work vehicle should not be operated in an autonomous mode due to issues with the braking system.

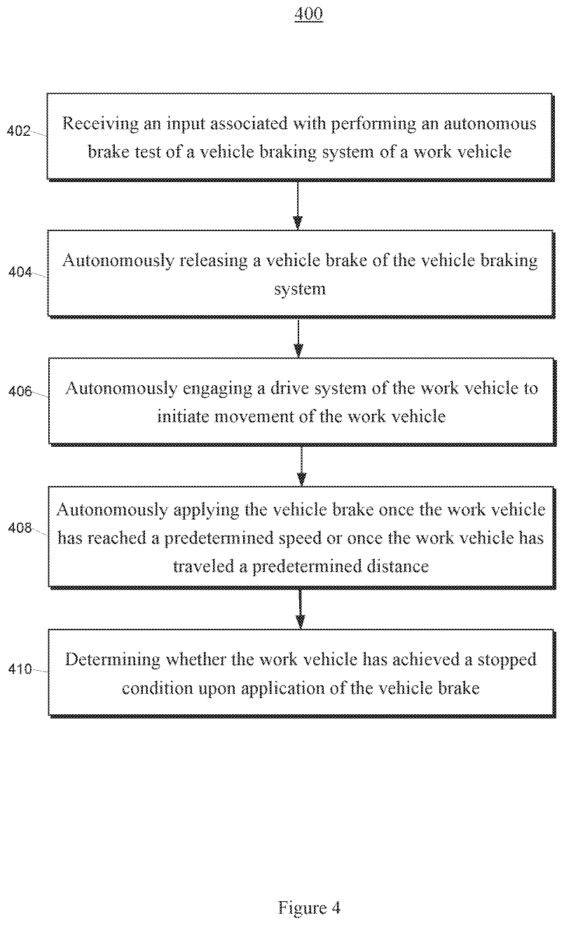

Referring now to FIG. 4, a flow diagram of another embodiment of a method 400 for automatically testing braking systems of a work vehicle is illustrated in accordance with aspects of the present subject matter. Although FIG. 4 depicts steps performed in a particular order for purposes of illustration and discussion, the methods discussed herein are not limited to any particular arrangement. One skilled in the art, using the disclosures provided herein, will appreciate that various steps of the methods disclosed herein can be omitted, rearranged, combined, and/or adapted in various ways without deviating from the scope of the present disclosure. Additionally, for purposes of discussion, any computer-implemented steps of the disclosed method 400 will be generally described herein as being performed by the computing system 202 shown and described above with reference to FIG. 2. However, one of ordinary skill in the art will appreciate that the various computer-implemented steps can generally be executed by any suitable computing system having any suitable system configuration.

As shown in FIG. 4, at (402), the method 400 may include receiving an input associated with performing an autonomous brake test of a vehicle braking system of a work vehicle. For instance, as indicated above, the computing system 202 may be configured to provide interactive test instructions 214 via the graphical user interface 215. In such an embodiment, the input received by the computing system 202 may be a selection from an operator to follow the test instructions 214 or to initiate the autonomous brake test. Alternatively, the input received by the computing system 202 may correspond to an input associated with a previously performed brake test. For instance, when performing a series of brake tests (e.g., similar to the method 300 described above), the input may correspond to a determination by the computing system 202 that a prior brake test has been performed and/or that it is now time to perform an additional brake test in view of the completion of a previous test.

Next, in response to the input, the computing system 202 may be configured, at (404), to autonomously release the vehicle brake while the work vehicle in the stopped condition. As discussed earlier, with a spring-applied, hydraulic release brake, this may be achieved by automatically controlling the hydraulic braking cylinder to disengage the brakes (e.g., by supplying pressurized fluid within the braking cylinder such that the cylinder disengages the brake against the bias of the spring-applied mechanism).

Thereafter, with the brakes disengaged, the computing system 202 may be configured, at 406, to autonomously engage the vehicle's drive system to initiate movement of the work vehicle. For instance, the computing system 202 may be configured to engage the drive system to move the vehicle forward at a predetermined speed or to a predetermined distance.

Moreover, at (408), when the work vehicle has reached a desired speed or when the work vehicle has traveled a desired distance, the computing system 202 may be configured to autonomously apply the vehicle brake in an attempt to bring the vehicle to a stop. For instance, the desired speed may be, for example, at least 0.5 kilometers per hour (KPH). In one embodiment, the desired driving speed for the work vehicle 10, such as the agricultural tractor or any other suitable work vehicle known in the art, can vary depending on various factors, including the specific operation being performed, terrain conditions, and/or the vehicle's capabilities. For instance, the speed may range from greater than 0.5 KPH to less than 15 KPH, such as greater 1 KPH to less than 12.5 KPH or greater than 2 KPH to less than 10 KPH and/or any other subranges therebetween. Additionally, in one embodiment, the desired distance may range from greater than 1 meter to less than 500 meters, such as greater 2 meters and less than 250 meters or greater than 5 meters and less than 150 meters or greater than 10 meters and less than 100 meters and/or any other subranges therebetweem. In general, using a desired speed and/or distance for the brake tests can ensure safety, performance evaluation, and reproducibility of result. It should also be appreciated that the desired speed and/or distance can vary depending on the specific stage of the test. Additionally, it should be appreciated that that the desired speed and/or distance for an autonomous brake test need not be fixed and can be adjusted based on the specific needs of the test, and/or regulatory requirements. Furthermore, during the testing process, vehicles may be tested at different speeds or distances to evaluate their performance across a wide range of scenarios and conditions.

Referring still to FIG. 4, at (410), the method 400 may include determining whether the work vehicle has been brought back into the stopped condition upon re-engagement of the brakes. Specifically, the computing system 202 may be configured to verify that the vehicle's brakes have successfully slowed the work vehicle down to a stopped condition (e.g., via the use of speed sensors, perception sensors, and/or the like). If the computing system 202 determines that the work vehicle is back in the stopped condition, the brake test may be considered to be successfully completed, which case the brake test procedure can be considered complete. However, if the work vehicle is still moving despite the computing system attempting to apply the brakes to stop the vehicle, the computing system 202 may be configured to perform a corrective safety action, as discussed earlier, to bring the work vehicle to a stop.

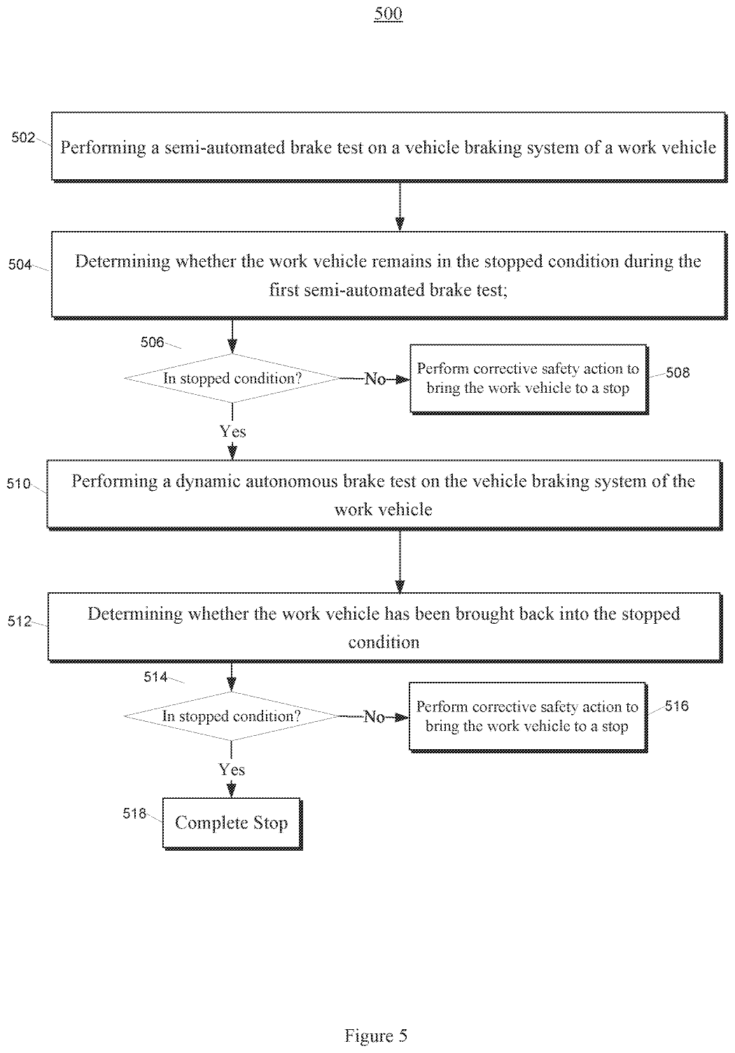

Referring now to FIG. 5, illustrating a flow diagram of a further embodiment of a method for automatically testing vehicle braking systems of a work vehicle in accordance with aspects of the present subject matter. Although FIG. 5 depicts steps performed in a particular order for purposes of illustration and discussion, the methods discussed herein are not limited to any particular arrangement. One skilled in the art, using the disclosures provided herein, will appreciate that various steps of the methods disclosed herein can be omitted, rearranged, combined, and/or adapted in various ways without deviating from the scope of the present disclosure. Additionally, for purposes of discussion, any computer-implemented steps of the disclosed method 500 will be generally described herein as being performed by the computing system 202 shown and described above with reference to FIG. 2. However, one of ordinary skill in the art will appreciate that the various computer-implemented steps can generally be executed by any suitable computing system having any suitable system configuration.

As shown in FIG. 5, at (502), the method 500 may include performing a semi-automated brake test on a vehicle braking system. To implement the first semi-automated brake test, the computing system 202 may be configured to prompt an operator (e.g., via the graphical user interface 215) to apply the vehicle's brakes (e.g., braking device 223 of braking system 222). For instance, the computing system 202 may provide interactive test instructions 214 prompting the operator to apply the brake pedal 21 or otherwise engage the braking device 223 of the work vehicle 10. Upon application of the brakes by the operator, the computing system 202 may be configured to autonomously engage the vehicle's drive system in an attempt to autonomously drive or move the vehicle while the operator maintains the brake in the applied state.

Next, at 504, the method 500 may include determining that the work vehicle remains in the stopped condition during the first semi-automated brake test. Specifically, the computing system 202 may be configured to verify that the vehicle's brakes have maintained the work vehicle in the stopped condition despite attempting to drive the work vehicle via engagement of the drive system. As shown at (506), if the computing system 202 determines that the work vehicle has remained in the stopped condition, the first semi-automated brake test may be considered to be successfully completed. However, if the work vehicle begins to move upon engagement of the vehicle drive system (and despite the brakes being applied), the computing system 202 may, at (508), be configured to perform a corrective safety action to bring the work vehicle to a stop. For instance, the computing system 202 may be configured to autonomously engage the drive system (e.g., by engaging the motor) or prompt the operator (e.g., via the graphical user interface 215) to bring the vehicle to a stop. In such instances, the computing system 202 may identify that the brake test was unsuccessful and, thus, the work vehicle should not be operated in an autonomous mode due to issues with the braking system.

Further, at (510), the method 500 may also include performing a dynamic autonomous brake test. As described above, to implement the dynamic autonomous brake test, the computing system 202 may be configured to autonomously release the vehicle brake while the work vehicle in the stopped condition. Thereafter, with the brakes disengaged, the computing system 202 may be configured to autonomously engage the vehicle's drive system to initiate movement of the work vehicle. For instance, the computing system 202 may be configured to engage the drive system in an attempt to move the vehicle forward at a predetermined speed or to a predetermined distance. After the work vehicle reaches a desired speed or upon the vehicle travels a desired distance, the computing system 202 may be configured to autonomously apply the vehicle brake in an attempt to bring the vehicle to a stop.

Referring still to FIG. 5, at (512), the method 500 may include determining whether the work vehicle has been brought back into the stopped condition. Specifically, the computing system 202 may be configured to verify that the vehicle's brakes have successfully slowed the work vehicle down to a stopped condition (e.g., via the use of speed sensors, perception sensors, and/or the like). As shown at (514), if the computing system 202 determines that the work vehicle is back in the stopped condition, the dynamic autonomous brake test may be considered to be successfully completed, in which case the brake test procedure can be considered complete (e.g., at 518). However, if the work vehicle is still moving despite the computing system attempting to apply the brakes to stop the vehicle, the computing system 202 may, at (516), be configured to perform a corrective safety action to bring the work vehicle to a stop. For instance, as indicated above, the computing system 202 may be configured to autonomously engage the drive system (e.g., by engaging the motor) or prompt the operator (e.g., via the graphical user interface 215) to bring the vehicle to a stop. In such instances, the computing system 202 may identify that the brake test was unsuccessful and, thus, the work vehicle should not be operated in an autonomous mode due to issues with the braking system.

In one embodiment, a stationary autonomous test may also be performed between the semi-automated brake test and the dynamic autonomous brake test. For example, the stationary autonomous brake test may be performed in a manner similar to that described above with reference to FIG. 3.

It is to be understood that the steps of the methods 300, 400, 500 are performed by the computing system 202 upon loading and executing software code or instructions, which are tangibly stored on one or more tangible computer readable media, such as on one or more magnetic media (e.g., a computer hard drive(s)), one or more optical media (e.g., an optical disc(s)), solid-state memory (e.g., flash memory), and/or other storage media known in the art. Thus, any of the functionality performed by the computing system 202 described herein, such as the methods 300, 400, 500, is implemented in software code or instructions, which are tangibly stored on the one or more tangible computer readable media. The computing system 202 loads the software code or instructions via a direct interface with the one or more computer readable media or via a wired and/or wireless network. Upon loading and executing such software code or instructions by the computing system 202, the computing system 202 may perform any of the functionality of the computing system 202 described herein, including any steps of the above-described methods 300, 400, 500.

The term “software code” or “code” used herein refers to any instructions or set of instructions that influence the operation of a computing system, such as one or more computers or one or more controllers. They may exist in a computer-executable form, such as machine code, which is the set of instructions and data directly executed by a computing system's central processing unit(s) or by a controller(s), a human-understandable form, such as source code, which may be compiled in order to be executed by a computing system's central processing unit(s) or by a controller(s), or an intermediate form, such as object code, which is produced by a compiler. As used herein, the term “software code” or “code” also includes any human-understandable computer instructions or set of instructions (e.g., a script) that may be executed on the fly with the aid of an interpreter executed by a computing system's central processing unit(s) or by a controller(s).

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A method for automatically testing vehicle braking systems, the method comprising:
receiving, with a computing system, an input associated with performing an autonomous brake test of a vehicle braking system of a work vehicle;
in response to the input, autonomously releasing, with the computing system, a vehicle brake of the vehicle braking system;
autonomously engaging, with the computing system, a drive system of the work vehicle to initiate movement of the work vehicle;
autonomously applying, with the computing system, the vehicle brake once the work vehicle has reached a predetermined speed or once the work vehicle has traveled a predetermined distance; and
determining, with the computing system, whether the work vehicle has achieved a stopped condition upon application of the vehicle brake.

2. The method of claim 1, wherein the computing system comprises a graphical user interface to provide interactive instructions to an operator of the work vehicle.

3. The method of claim 1, wherein the computing system determines the stopped condition according to a response from at least one sensor.

4. The method of claim 1, wherein autonomously applying the vehicle brake comprises autonomously applying the vehicle brake once the work vehicle has reached the predetermined speed, wherein the predetermined speed is at least 0.5 kilometers per hour.

5. The method of claim 1, wherein, when the computing system determines the work vehicle is not in the stopped condition upon application of the vehicle brake, the computing system is configured to perform a corrective action to bring the work vehicle into the stopped condition.

6. The method of claim 5, wherein the corrective action comprises automatic engagement of the drive system to bring the work vehicle into the stopped condition.

7. The method of claim 5, wherein the corrective action comprises prompting an operator to apply the vehicle brake of the vehicle braking system to bring the work vehicle into the stopped condition.

8. The method of claim 1, wherein receiving the input associated with performing an autonomous brake test comprises receiving an input associated with a previously performed brake test of the vehicle braking system.

9. The method of claim 1, wherein the vehicle brake is a spring applied, hydraulic release brake, wherein autonomously releasing the vehicle brake comprises supplying pressurized fluid to a braking cylinder associated with the vehicle brake and wherein autonomously applying the vehicle brake comprises releasing pressurized fluid from the braking cylinder associated with the vehicle brake.

10. A method for automatically testing vehicle braking systems, the method comprising:
performing, with a computing system, a first semi-automated brake test on a vehicle braking system of a work vehicle while the work vehicle is in a stopped condition, wherein performing the first semi-automated brake test comprises:
prompting an operator to apply a vehicle brake of the vehicle braking system;
autonomously engaging a drive system of the work vehicle while the operator maintains the vehicle brake applied;
determining, with the computing system, whether the work vehicle remains in the stopped condition during the performance of the first semi-automated brake test;
performing, with the computing system, a second autonomous brake test on the vehicle braking system, wherein performing the second autonomous brake test comprises:
autonomously releasing the vehicle brake with the work vehicle in the stopped condition;
autonomously engaging the drive system of the work vehicle to initiate movement of the work vehicle;
autonomously applying the vehicle brake once movement of the work vehicle has been initiated; and
determining, with the computing system, whether the work vehicle has been brought back into the stopped condition after the work vehicle has reached a predetermined speed or once the work vehicle has traveled a predetermined distance.

11. The method of claim 10, wherein after determining the work vehicle remains in the stopped condition during the performance of the first semi-automated brake test, performing, with the computing system, a third autonomous brake test on the vehicle braking system of the working vehicle while the work vehicle is in the stopped condition, wherein performing the third autonomous brake test comprises:
autonomously engaging the drive system of the work vehicle while the vehicle brake of the vehicle braking system is maintained in an engaged state;
determining, with the computing system, whether the work vehicle remains in the stopped condition during the performance of the third autonomous brake test.

12. The method of claim 10, wherein the computing system comprises a graphical user interface to provide interactive instructions to the operator of the work vehicle.

13. The method of claim 10, wherein the computing system determines the stopped condition according to a response from at least one sensor.

14. The method of claim 10, wherein autonomously applying the vehicle brake comprises autonomously applying the vehicle brake once the work vehicle has reached the predetermined speed, wherein the predetermined speed is at least 0.5 kilometers per hour.

15. The method of claim 10, wherein, when the computing system determines the work vehicle is not in the stopped condition upon application of the vehicle brake, the computing system is configured to perform a corrective action to bring the work vehicle into the stopped condition.

16. The method of claim 15, wherein the corrective action comprises automatic engagement of the drive system to bring the work vehicle into the stopped condition.

17. The method of claim 15, wherein the corrective action comprises prompting the operator to apply the vehicle brake of the vehicle braking system to bring the work vehicle into the stopped condition.

18. The method of claim 10, wherein the vehicle brake is a spring applied, hydraulic release brake, wherein autonomously releasing the vehicle brake comprises supplying pressurized fluid to a braking cylinder associated with the vehicle brake and wherein autonomously applying the vehicle brake comprises releasing pressurized fluid from the braking cylinder associated with the vehicle brake.
